(19) United States
(12) Patent Application Publication
(10) Pub. No.: US 2020/0183487 A1
(43) Pub. Date: Jun. 11, 2020

(54) WALKABLE DEVICE AND METHOD FOR CONTROLLING A WALKABLE DEVICE

(71) Applicant: Pathbender GMBH, Ronnenberg (DE)

(72) Inventors: Julia Reineke, Ronnenberg (DE); Tobias Reineke, Ronnenberg (DE)

(21) Appl. No.: 16/784,436

(22) Filed: Feb. 7, 2020

Related U.S. Application Data
(63) Continuation-in-part of application No. 15/558,733, filed on Sep. 15, 2017.

(30) Foreign Application Priority Data
Jun. 16, 2015 (DE) 10 2015 007 728.7

(51) Int. Cl. G06F 3/01

(52) U.S. Cl. CPC G06F 3/011; G06F 2203/012

(57) ABSTRACT

The present invention relates to a walkable device, for example used for control of an avatar in a computer-generated environment, and a method for controlling the walkable device. In a virtual reality environment the immersion is increased by virtue of the claimed walkable device and the method for controlling same, allowing the user a natural walking experience, without spatial limits, with a familiar anatomy and an authentic feeling of body presence.

### CROSS-REFERENCE TO RELATED APPLICATIONS

This application is a continuation-in-part of application Ser. No. 15/558,733, filed 2017 Sep. 15, which is a national stage entry of PCT/EP2016/000860, filed 2016 May 24, which claims benefit of priority to DE 10 2015 007 728.7, filed 2015 Jun. 16, the entire disclosures of which are hereby incorporated herein by reference.

### FIELD OF THE INVENTION

The invention relates to a walkable device, for example used for control of an avatar in a computer-generated environment, and a method for controlling a walkable device.

### BACKGROUND

As the closest prior art, JP2001171815A discloses a device comprising a stationary conveyor belt with a rotatable guide on top and containing rolling elements which provide a walkable surface for a person. The apparatus is equipped with a two-dimensional position control. If the person moves away from the center of the guide in either direction, the device responds with a special maneuver. This maneuver involves a rotation of the guide and/or a transport movement of the conveyor belt and always transports the person back to the center of the walkable area.

The kinematics of JP2001171815A will be illustrated by the following simple examples. If the person turns in place in the center of the guide, the device does not respond because the rotation angle of the person is not detected and is irrelevant to the position control. However, in case of the person walking transversely to the transport direction of the conveyor belt, the person is rotated by the guide so that the walking direction is aligned again with the transport direction of the conveyor belt, and thus the conveyor belt is able to convey the person back to the center of the walkable area. However, this type of control is unfavorable, since it rotates the person in an unexpected way when walking transversely to the transport direction of the conveyor belt, which may result in the walker feeling queasy. In case of the device providing just a small guide with a limited walkable surface, this rotation response has to be quick and promptly to prevent the person from leave the walkable area unintentionally. An example for means for rotating the guide is given in JP2001171815A at sections [0051] and [0052] which also describe in detail a means for rotating the guide for a device comprising a rotatable guide with rolling bodies mounted on top of a conveyor as it is described in this invention.

### SUMMARY

The present invention relates to a walkable device, for example used for control of an avatar in a computer-generated environment, and a method for controlling the walkable device. In a virtual reality environment the immersion is increased by virtue of the claimed walkable device and the method for controlling same, allowing the user a natural walking experience, without spatial limits, with a familiar anatomy and an authentic feeling of body presence.

The foregoing and other features of the invention are hereinafter described in greater detail with reference to the accompany drawings.

### BRIEF DESCRIPTION OF DRAWING

The accompanying drawing, which is not necessarily to scale, shows various aspects of the disclosure.

FIG. 1 illustrates a walkable device according to the present disclosure.

### DESCRIPTION

The object of the present invention is to avoid the disadvantages of JP2001171815A in terms of comfort, which especially occur for a small and economical to manufacture device having only a small-sized walkable surface. The object of the present invention is achieved by restricting the walker in his freedom of movement in a way that may be nonsensical to the expert.

The solution of the problem is disclosed in claim 1 of the present invention, in which the two-dimensional position control according to the prior art is replaced by a one-dimensional position control in combination with an angle control.

An angle sensor may be the Microsoft Kinect or the HTC Vive Tracker or a mobile phone having rotational sensors. The angle sensor may be a visual sensor, for example with a camera device, for detecting points, e.g. visual recognizable points or markers, within a field of view or detection area. The angle sensor may be a sensor for detecting a magnetic field or a change of a magnetic field or a moving, like a positional change, of a magnet or magnets within a detection area. The magnet can be an electromagnet and/or the magnetic field can be an electromagnetic field. The angle sensor may detect the rotation of the person. This rotational information may then be transformed by means of a calculation unit performing an angle control algorithm into a signal to control the drive to control the walkable surface or the guide to thereby counter with a counterrotation angle in such a way that it always and immediately counteracts the rotation of the person, such as without the person being aware or being only minimally aware of the counterrotation.

The calculation unit and angle sensor are at least communicatively connected with one another and with the walkable device, also herein referred to as an input device, such that signals and data relating to the position of a user on the walkable device can be transferred therebetween.

In contrast to the prior art, the device of the present invention has an entirely different kinematics, because it reacts immediately to the angular orientation of the person on the walkable surface. However, with the device of the present invention it is not possible to walk transversely to the frontal direction of the person. In contrast to the prior art, especially a lateral movement by unlimited side-steps is no longer possible with the present invention.

The advantages of the subject disclosed in claim 1 are based on a different kind of control method which always provides a comfortable walking experience, especially when the walkable surface of the device is small. The comfort while walking in virtual reality could be enhanced even further, using a soft-elastic enclosure around the walker's hip or thighs. It is also advantageous if the inventive device compensates for instinctive “lean back” during braking or “laterally tilting” during cornering with a sensitive but nimble tilting of the walking surface about horizontal axes. The tilting of the walking surface is then also used for the simulation of inclination in a virtual environment. Supplying some objects or obstacles from the virtual reality also in the real environment as a dummy, approaching the user from the proper direction and distance and with the proper speed, for example by a hinged bracket with corresponding attachments at its end, is another possibility to enhance the immersion in the virtual environment.

The invention is explained in more detail below with reference to the drawings.

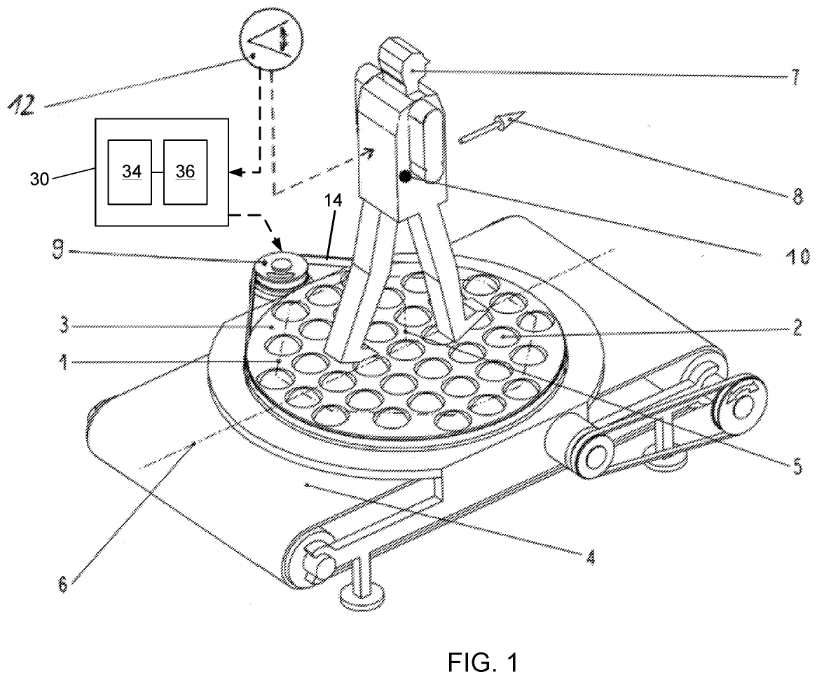

FIG. 1 shows the input device according to the invention in a highly simplified illustration with the conveyor belt, the guide with rolling bodies, the drives and detection means as well as the person with some of the possible body joints. In order to allow the cornering to be possible, the guide (3) is equipped with a bearing, so that the guide with the rolling bodies (2) can be rotated about an axis of rotation (5) by means of a drive (9) and a pulley (14). The drive (9) includes a motor and a motor-control for controlling the rotation of the walkable surface (1) and/or guide (3).

The rolling bodies (2) protrude from the top of the guide (3) and form/define the walkable surface (1) on which a person (7), also herein referred to as a user, is walking or standing. The angle sensor (12) detects the rotation of the person (7) about the axis perpendicular to the walkable surface. That is, the angle sensor (12) detects a rotational angle of the person (7) along a guide plane generally parallel to the walkable surface (1) and about an axis transverse to the guide plane, such as an axis perpendicular to the guide plane. The motor-control is able to receive a signal which is based on the rotation of the person (7), about the axis perpendicular to the walkable surface (1).

That is, rotational and angular information from the angle sensor (12) is then transformed by means of a calculation unit performing an angle control algorithm into a signal to control the drive (9) to rotate the walkable surface (1) and/or the guide (3) in such a way that the respective counterrotation always and immediately counteracts the rotation of the person (7). That is, the walkable surface (1) and/or the guide (3) is controlled, such as by a control system (30), to counter the rotation of the person (7) with a counterrotation with respect to the rotation of the person (7). If the person (7) is located in the center of the guide (3) and performs a rotation in place, the guide (3) always and immediately executes a counterrotation, which completely compensates the rotation of the person (7) so that the person (7) indeed fulfills the necessary body movements for a rotation but without the person (7) actually turning themselves around. For example, the angular correction is such that it goes generally unnoticed by the person (7) moving on the walkable surface (1).

As but one example, the detection means (12) can acquire the spatial body posture of the person (7) by means of depth information to transform it into body joints (11), preferably the right and left shoulder and pelvis and thereby detects the rotation of the person (7), and the positions of the body joints (11) influence the rotation of the guide (3) by means of an angle control. The body joints (11) preferably for the left and right shoulder and pelvis, by connecting a left body joint (11) with a corresponding right one by means of a straight line, and by the perpendicular projection of this connection lines onto the walking surface (1), angular differences relative to the longitudinal center line (6) are obtained, which then, as a weighted average of the angular differences influences the rotation of the guide (3) by means of an angle control, in such a way that the weighted average of the angular difference continuously corresponds to a desired value of preferably 90°.

Thus the walking direction (8) of the person (7) is always parallel to the longitudinal center line (6) of the conveying device (4) and during walking the person (7) is simply and directly centered in the middle of the guide (3) by means of a one-dimensional position control. Instead of being exposed to violent and unexpected reactions, the persons (7) is always at rest in regard to their position and angular orientation compared to the real physical environment while turning in place or while walking straight and in curves. The angular orientation of the person (7) could (for example) also be calculated from their posture by means of the position of their body joints (11). Advantageously, the positions of each individual body joint (11) is also be used to control the limbs of the avatar in the virtual environment.

If there is no transport movement induced by the conveying device (4), the rotational center of the guide (3) and the rotational center of the walking surface (1) are located coincident in the center of the guide (3). If the person (7) is located laterally thereof, the rotational center of the walking surface (1) is shifted by the amount of the persons lateral offset towards the position of the person (7), by means of an addition of the velocity vectors of the guide rotation and the velocity vectors of the transport movement of the conveying device (4). The basis for this is the fact that a velocity vector addition of a rotation and a translation in the same plane again results in a rotation with the same angular velocity, but with the pivot point displaced orthogonally to the direction of translation. As a result, the input device is equipped with a pivot point displacement, wherein the rotational center of the walking surface (1) is displaced about the lateral deviation of the person (7) from the axis of rotation (5), viewed along the longitudinal center line (6), and thus the center of rotation of the walking surface (1), viewed along the longitudinal center line (6), is always located perpendicularly under the position of the person (7) when the latter is standing on the walkable surface, laterally offset to the axis of rotation (5), and rotates there.

This is achieved with the distance between the lateral control point (10) and the axis of rotation (5), viewed along the longitudinal center line (6), as a scaled product with the angular velocity of the guide (3), is added to the transport movement of the conveying device (4), and thereby the rotational center point of the walking surface (1) is displaced about the distance between the lateral control point (10) and the axis of rotation (5) and thus the center of rotation of the walking surface (1), viewed along the longitudinal center line (6), is always located perpendicularly under the position of the person (7) when the latter is standing laterally offset to the axis of rotation (5) on the walkable surface, and rotates there. In case of a person rotating in a laterally offset position on the walking surface (1), the conveying device (4) performs a defined transport movement in addition to the rotation of the guide (3), whereby as a result the pivot point of the walking surface (1), viewed along the longitudinal center line (6), is positioned perpendicular to the position of the person (7).

As indicated above, the walkable device further includes the control system (30), which is generally schematically illustrated at FIG. 1, for controlling operation of the input device in response to a signal(s)/data received from the angle sensor (12). The control system (30) includes at least a processor (34), such as the calculation unit, and a storage (36), such as a memory, which in other embodiments may be integral with the processor (34). The control system (30), any of its elements, and/or the angle sensor (12) may be included in the walkable device and/or any of these aspects may be located separately from but in communication with the walkable device.

A “processor” as used herein refers to any, or part of any, electrical circuit comprised of any number of electrical components, including, for example, resistors, transistors, capacitors, inductors, and the like. The circuit may be of any form, including, for example, an integrated circuit, a set of integrated circuits, a microcontroller, a microprocessor, a collection of discrete electronic components on a printed circuit board (PCB) or the like. The processor may also stand alone or be part of a computer used for operations other than those of controlling the walkable device. Implementation of movement control of the walkable device may by hardware or software may be realized in any number of electronic devices and/or applications, including but not limited to, personal computers, servers, mobile phones, and the like. Moreover, the above aspects and/or combination of aspects may be stored in memory which is executable by one of said processors. It is also to be noted that the above description is non-limiting, and the examples are but only a few of many possible processors and implementations envisioned.

The storage (36) can include any suitable architecture for storing information to assist with operation of the walkable device. The storage (36) can provide a non-transient computer readable medium for containing program instructions for causing the processor (34) to perform one or more steps of one or more movement methods and/or calculations. For example, program instructions for implementing the angle control algorithm may be included in the storage (36) and read and/or implemented by the processor (34).

In other embodiments some or all of the program instructions for implementing the angle control algorithm may be disposed at an external database communicatively connected to the control system (30) for being accessed by the control system (30). Such communication may be by way of any suitable wired or wireless connection, such as Bluetooth, Zigbee, cellular, WiFi, token ring, or the like.

### LIST OF REFERENCE NUMBERS

1 walking surface
2 rolling bodies
3 guide
4 conveying device
5 axis of rotation (of the guide)
6 longitudinal center line (of the conveyor)
7 person
8 walking direction
9 drive
10 lateral control point
12 angle sensor
14 pulley
30 control system
34 processor
36 storage

1. A walkable device, comprising a walkable surface (1) for a person (7), a conveying device (4) located at an installation site, and a guide (3) attached to the conveying device (4), the guide (3) including rolling bodies (2) arranged in the guide (3), the rolling bodies (2) defining the walkable surface (1) and at least some of the rolling bodies (2) interacting with the conveying device (4), and wherein the guide (3) with rolling bodies (2) is rotatable relative to the conveying device (4) about an axis of rotation (5) which is perpendicular to the walkable surface (1), wherein the walkable device further comprises a drive (9) with a motor and a motor-control for controlling the rotation of the guide (3), the motor-control being able to receive a signal which is based on the rotation of the person (7), about an axis perpendicular to the walkable surface (1), wherein the rotation of the person (7), about the axis perpendicular to the walkable surface (1) induces a rotation of the guide (3) to counteract the rotation of the person (7) such that the walking direction (8) of the person (7) remains aligned to the transport direction of the conveying device (4).

2. The walkable device according to claim 1, further comprising an angle-sensor (12) for detecting the rotation of the person (7) about the axis perpendicular to the walkable surface (1).

3. The walkable device according to claim 2, further comprising a calculation unit for processing the detected rotation of the person (7) about the axis perpendicular to the walkable surface (1), wherein the calculation unit is in communication with the motor-control.

4. The walkable device according to claim 1, wherein the motor control is configured to control the rotation of the guide (3) based on the received signal such that the rotation of the guide (3) counteracts the rotation of the person (7).

5. A method for controlling a walkable device comprising a walkable surface (1) for a person (7), a conveying device (4) located at an installation site, and a guide (3) attached to the conveying device (4), the guide (2) including rolling bodies (2) arranged in the guide (3), the rolling bodies (2) defining the walkable surface (1) and at least some of the rolling bodies (2) interacting with the conveying device (4), and the guide (3) with rolling bodies (2) being rotatable relative to the conveying device (4) about an axis of rotation (5) which is perpendicular to the walkable surface (1), the method comprising: wherein the rotation of the guide (3) is performed by a drive (9) comprising a motor and a motor-control, wherein the rotation of the person (7), about an axis perpendicular to the walkable surface (1), is detected by an angle-sensor (12) and processed by a calculation unit being in communication with the motor-control for rotation of the guide (3) and wherein the rotation of the person (7), about the axis perpendicular to the walkable surface (1), induces a rotation of the guide (3) to counteract the rotation of the person (7) about the axis perpendicular to the walkable surface (1) such that the walking direction (8) remains aligned to the transport direction of the conveying device (4).

6. The method for controlling a walkable device according to claim 5, characterized in that the distance between a lateral control point (10) and the axis of rotation (5), viewed along a longitudinal center line (6), as a scaled product with the angular velocity of the guide (3), is added to the transport movement of the conveying device (4), and thereby the rotational center point of the walkable surface (1) is displaced about the distance between the lateral control point (10) and the axis of rotation (5) and thus the center of rotation of the walkable surface (1), viewed along the longitudinal center line (6), is always located perpendicularly under the position of the person (7) when the latter is standing laterally offset to the axis of rotation (5) on the walkable surface, and rotates there.
